(19) United States
(12) Patent Application Publication
(10) Pub. No.: US 2020/0097949 A1
(43) Pub. Date: Mar. 26, 2020

(54) SYSTEMS AND METHODS FOR DEBIT CARD ISSUANCE

(71) Applicant: ALTERNA CARD SERVICES, INC., Sausalito, CA (US)

(72) Inventor: Madeleine Tapia, Menlo Park, CA (US)

(21) Appl. No.: 16/505,330

(22) Filed: Jul. 8, 2019

Related U.S. Application Data
(63) Continuation of application No. 15/256,407, filed on Sep. 2, 2016, now abandoned.
Application No. 15/256,407 is a continuation of application No. 13/902,159, filed on May 24, 2013, now abandoned.
(60) Provisional application No. 61/655,948, filed on Jun. 5, 2012.

(51) Int. Cl. G06Q 20/34; G06Q 20/26; G06Q 30/06; G06Q 40/02

(52) U.S. Cl. CPC G06Q 20/354; G06Q 20/26; G06Q 50/265; G06Q 20/355; G06Q 40/025; G06Q 30/0621

(57) ABSTRACT

Systems and methods may be provided for debit card issuance. An individual at a retailer may purchase a pre-paid debit card. The individual may provide documentation relating to the individual's identity. A check may be conducted. If verification occurs, a reloadable personalized card may be provided to the individual. The individual may or may not provide a social security number for verification. In some instances, a social security number may not be required in order to utilize the system.

### CROSS REFERENCE

This application is a continuation of application of U.S. application Ser. No. 15/256,407, filed Sep. 2, 2016, which is a continuation application of U.S. application Ser. No. 13/902,159, filed May 24, 2013, which claims the benefit of U.S. Provisional Application No. 61/655,948, filed Jun. 5, 2012, which applications are incorporated herein by reference.

### BACKGROUND OF THE INVENTION

Traditional prepaid debit cards require users to registering prior to receiving a personalized card. The registration requires the user to enter their social security number. This disadvantageously prevents users who do not have social security numbers from utilizing such a debit card.

A need exists for improved systems and methods for prepaid debit card issuance. A further need exists for improved systems and methods for in-store registration and sale of a one-time load fully flagged prepaid debit card which may trigger the issuance of a reloadable personalized fully flagged prepaid debit card and/or reloadable personalized ATM cards.

### SUMMARY OF THE INVENTION

An in-store registration and sale process may allow retail retailers to register and sell an instant issued, one-time load, fully flagged prepaid debit card which may trigger the issuance and mailing of a reloadable personalized fully flagged prepaid debit card and/or reloadable personalized prepaid ATM cards and to perform a one-time load of the instant issued card. The process may allow the retailer to: (1) Verify the CIP (“Customer Identification Program” as directed by the Card Act) documentation for non-U.S. citizens living in the U.S. who want to purchase a reloadable, personalized, fully flagged prepaid debit card; (2) Enter online the information required by the program manager and issuing bank for the approval, registration and sale of a one-time load, fully flagged prepaid debit card which triggers the issuance of a reloadable personalized fully flagged prepaid debit card as well as the issuance of reloadable personalized ATM cards and if real time approval occurs; and/or (3) Sell and load the instant issued one-time load fully flagged prepaid debit card. This process may also allow the same for U.S. Citizens to register for and purchase said cards in-store with an added step of calling the prepaid debit card company's PCI compliant customer service to provide the customer's Social Security Number.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are used, and the accompanying drawings of which:

FIG. 1 shows a high level view of entities involved in system in accordance with an embodiment of the invention.

FIG. 2 shows an example of a system for debit card issuance in accordance with an embodiment of the invention.

FIG. 3 shows an example of a method for debit card issuance in accordance with an embodiment of the invention.

FIG. 4 shows additional steps that may be provided for a U.S. citizen for debit card issuance in accordance with an embodiment of the invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed in practicing the invention.

The invention provides systems and methods for debit card issuance. Various aspects of the invention described herein may be applied to any of the particular applications set forth below or for any other types of prepayment or financial applications. The invention may be applied as a standalone system or method, or as part of an integrated data aggregation or confirmation system. It shall be understood that different aspects of the invention can be appreciated individually, collectively, or in combination with each other.

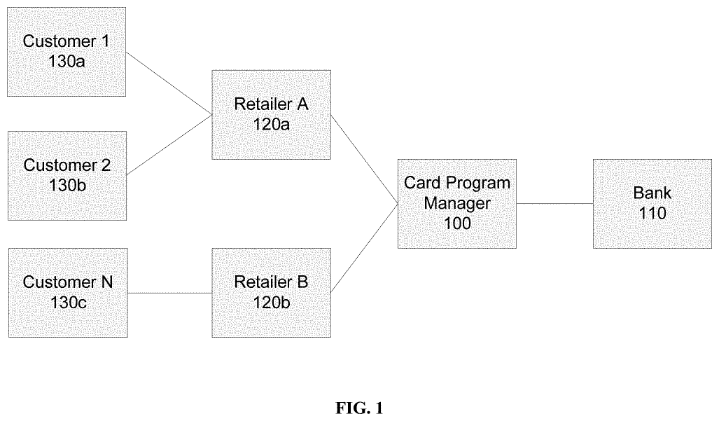

FIG. 1 shows a high level view of entities involved in system in accordance with an embodiment of the invention. A card program manager 100 may interact with a bank 110 and one, two or more retailers 120a, 120b. The one or more retailers may interact with one, two or more customers 130a, 130b, 130c. A card program manager may interact with any number of banks or retailers. Retailers may interact with any number of customers.

A program manager 100 of the card program may have a retailer 120a, 120b sign an agreement between the retailer, the issuing bank 110 of a prepaid debit card and the program manager for the selling and the loading of the cards. Said agreement may contain all credit information of the retailer required by the program manager and/or the issuing bank.

If the retailer is approved by the program manager and/or the issuing bank, a payment card industry (PCI) compliant prepaid debit card processor may assign a retailer ID to said retailer. The PCI compliant prepaid debit card processor may or may not be the same or different entity as the program manager and/or issuing bank. Each retailer may have a unique retailer ID. The retailer may or may not communicate directly with the issuing bank. In some instances, the retailer may or may not only communicate with the bank via the program manager.

Once the retailer is approved, issuing bank and/or program manger may certify a compliance officer of each retailer for the loading of the instant issued cards.

One or more customers 130a, 130b, 130c may interact with one or more retailers 120a, 120b. The customers may purchase, at the retailer, a non-personalized, single load, temporary card that is replaced via mail with a personalized permanent card. The retailer may be a point of sale for the customers to access the cards. The customers may be able to activate the card at the retailer site. In some instances, personalized reloadable cards may be sent to the customer's address. Personalized reloadable cards may be provided to the customer after a verification process has occurred. In some instances, the program manager may perform the verification for the customer. The verification may include verification of the customer's identity. Additional verification may incorporate the customer's financial status, and/or address.

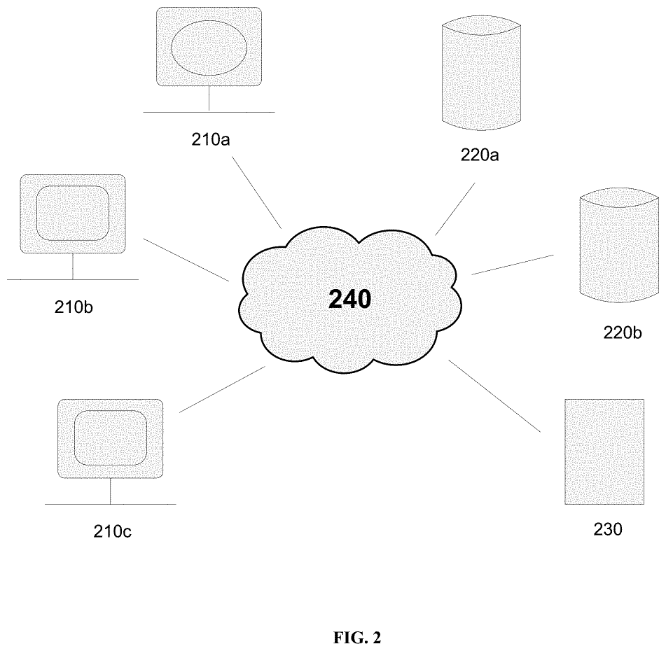

FIG. 2 shows an example of a system for debit card issuance provided in accordance with an embodiment of the invention. One or more device 210a, 210b, 210c may be in communication over a network 240 with one or more server 230 and/or database 220a, 220b.

In some embodiments, a device 210a, 210b, 210c may be a server, personal computer, laptop computer, tablet, mobile device, cell phone, satellite phone, smart phone (e.g., iPhone, Android, Blackberry, Palm, Symbian, Windows), personal digital assistant (PDA), pager or any other device. The device may be a device capable of communicating over a network. The device may have a memory and a programmable processor. The memory may store non-transitory computer readable media, which may comprise code, logic, or instructions for performing one or more steps described herein. The processor may execute one or more step. The device may be a telephone or other device capable of communicating with additional devices. The device may permit wired or wireless communication.

The devices may have a display that may permit a user interface to be displayed. The display may be a screen, touchscreen, LCD display, LED display, OLED display, CRT display, plasma display, or any other type of display. The display may permit visual depiction of information and/or audio depiction of information. A user interface may permit a user to interact with the system. For example, a user interface may be displayed for an online enrollment form where a retailer may enter information about a customer. The devices may be equipped with a camera, scanner, or other image capture device, or may be capable of receiving information from a camera, scanner, or other image capture device. The image capture device may capture an image of the customer and/or documentation from the customer. Such documentation may be useful for verifying the identity of the customer.

In some instances, the system may be a browser-based system. A web browser may be operating on the device. The browser may display a user interface through which a user may interact with the system. The user interface may permit a user to communicate with the server and/or databases.

The device may be used at a retailer site. For example, a retailer may provide in-store online registration of a card purchased by a customer. In some instances, one or more device may be used by a bank or card program manager in order to access information. In some instances, a customer may utilize a device to provide further registration and/or ordering personalized pre-paid ATM family cards.

One or more server 230 may communicate with the devices over a network 240. In some instances, the network may be a local area network (LAN) or wide area network (WAN) such as the Internet. The network may be any sort of telecommunications network, such as a cellular network or telephone line network.

A server 230 may have a memory and programmable processor. The server may be hosted and/or operated by a card program manager. Alternatively, the server may be hosted and/or operated by a bank, retailer, or any third party entity. The server may be capable of receiving information from the retailers and assisting with confirming the identity of one or more customers. The server may access information from one or more database 220a, 220b. The server may access information from the one or more databases in order to verify the identity of the customer. The server may compare the information received from one or more retailers with information stored in the databases. The server may provide new information to the databases.

The databases may or may not be owned and/or operated by the same entity as the server. The databases may be owned and or operated by a bank, card program manager, retailer, or any combination thereof. The databases may include public information, or information collected by a governing body or other entity. The retailers may or may not be able to access the databases directly. In some instances, the retailers may only access the databases via the card program managers. In some instances, information may be collected from public and/or governmental sources via web crawling or other forms of access. In some instances, an entity may be required to be authorized in order to access some of the information. The card program manager and/or bank may be granted authorized access to some of the information. The servers and/or devices may communicate with the databases over a network 240. In some alternate embodiments, a peer to peer architecture may be used, or cloud computing architecture may be provided.

A program manager may be capable of accessing the databases, thereby accessing information therein. The program manager may verify the identity of a customer and/or additional information relating to the customer. Such verification may occur with aid of a programmable processor. In some instances, verification may occur in an automated fashion without requiring human intervention. Alternatively, in some instances human intervention may occur.

The systems and methods may provide an in-store registration process, which may be for a dual card program where the customer may purchase a non-personalized, single load, temporary card that may be replaced via mail with a personalized permanent card. The CIP and Office of Foreign Assets Control (OFAC) verification may be performed at the time of purchase of the instant-issue card in the retail store via an in-store online registration interface that may be connected to the card's processor's platform so that the permanent card can be mailed to the customer. The customer may also have the option of ordering reloadable personalized prepaid ATM family cards at the time of purchase of the instant-issued card. No CIP may be required for the family card. In some instances, it is only necessary to perform an OFAC check on the individual whose name appears on the family card.

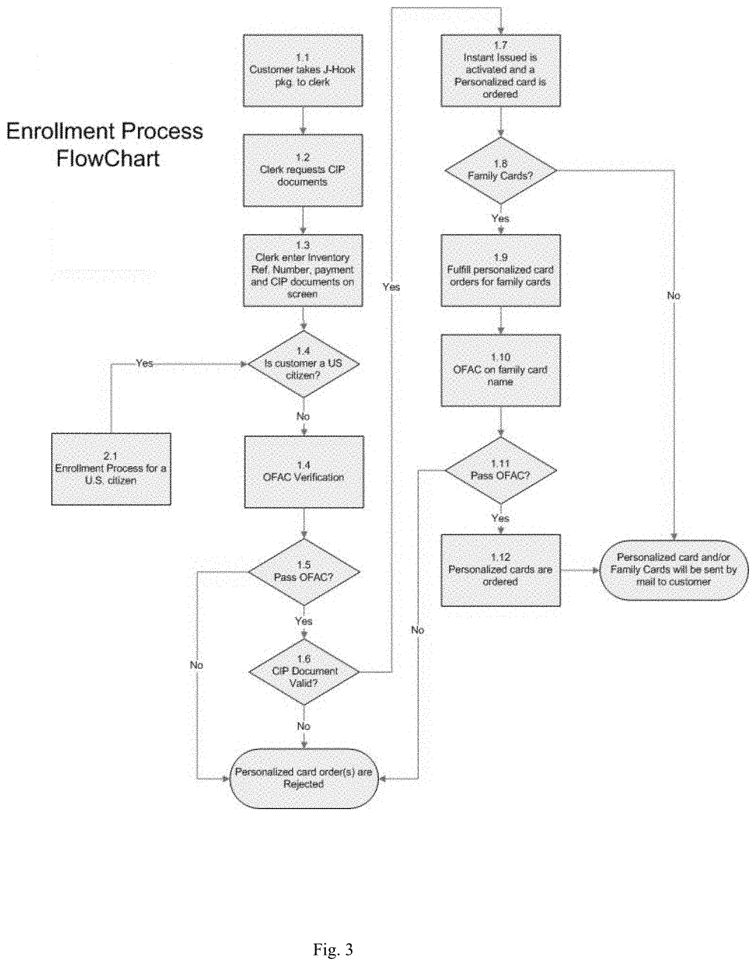

FIG. 3 shows an example of a method for debit card issuance in accordance with an embodiment of the invention. In some instances, the method may permit the issuance of a prepaid temporary card and/or personalized reloadable cards without requiring that the customer be a U.S. citizen (or citizen of the country of issuance of the card). The method may permit the issuance of cards to an individual who may not have a U.S. Social Security number. The method may permit the use of cards in the United States (or the country of issuance of the card). In other embodiments, the cards may be used outside the United States (or the country of issuance of the card). Such a method may operate in compliance with governmental and other regulations.

A customer may take a package to a clerk 1.1. The package may be for a non-personalized temporary card. The package may be provided at a retailer site.

The clerk may request identification and/or documentation from the customer 1.2. The clerk may request any sort of document that may verify the identity of the customer. For example, a driver's license, green card, passport, social security card, employment card, mail, or any other documentation may be requested. In some embodiments, the documentation may be CIP documentation. In some embodiments, the customer may complete a short enrollment form. The program manager may be responsible for printing and stocking the enrollment forms in the store. The program manager may send or provide the enrollment forms to the retailer site. Information about the customer may be collected. For example, one or more of the following: the customer name, address, phone number, date of birth, place of birth, country of citizenship, social security number, passport information, driver's license information, or any other type of information may be collected.

The clerk may enter data and/or send data based on data received from the customer 1.3. For example, the store clerk may enter the data from the enrollment form into an online form. This data may be entered manually. Alternatively, the clerk may ask the customer verbal questions and enter the answers into the online form. In another example, the customer may enter information into the online form, under or not under the supervision of the store clerk. The online form may be displayed on a device of the retailer. The store clerk may access the online form via a browser or application of the device. In some embodiments, the data provided into the online form may include an inventory reference number, payment, and/or CIP documents, or information from such documents.

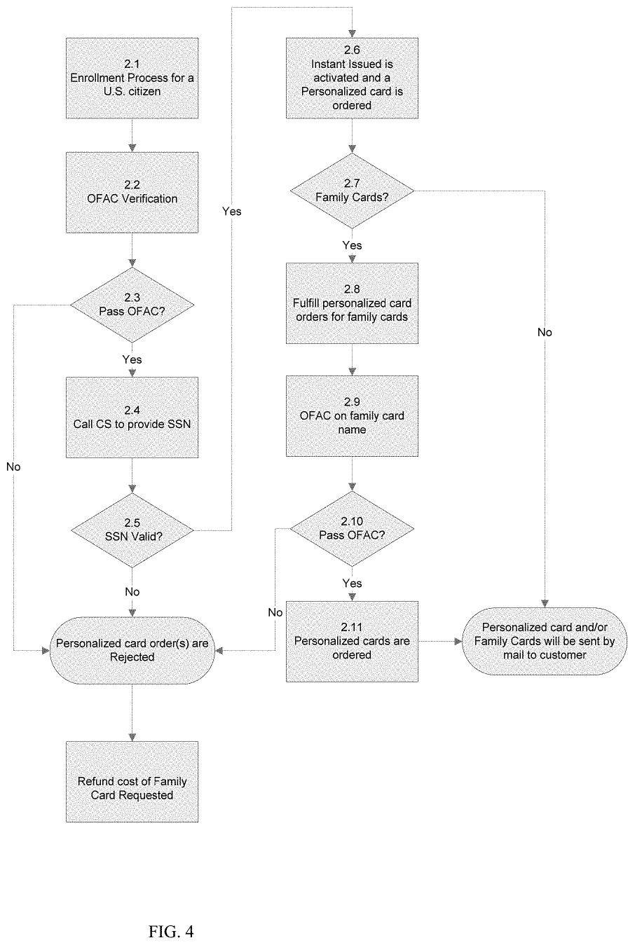

It may be ascertained whether the customer is a U.S. citizen 1.4. The online form may include a checkbox for U.S. citizenship. Customers that are U.S. citizens may be required to have a social security number (SSN) before a replacement reloadable personalized card can be shipped to the cardholder. FIG. 4 provides examples of steps that may be utilized for U.S. citizens 2.1.

If the customer is not a U.S. citizen, OFAC verification may occur 1.4. Non-U.S. citizens may not have a social security number (SSN). Customers who are citizens of other countries but do not have a U.S. SSN can provide alternate documentation that is acceptable to a Bank Sponsor. Thus, the identity of the customer may be verified without requiring a social security number and/or citizenship. In some instances, documentation that may be sufficient for OFAC verification may be sufficient for a bank sponsor. One, two, three or more of the following documents may be provided: Matricula Consular, non-U.S. Passport, foreign driver's license, foreign military ID, and/or unexpired government issued photo ID from customer's country of origin. The customer may be capable of providing documentation and/or other forms of identification that may comply with governmental regulations and/or authorities. The clerk may check a box on the online screen confirming that he or she has reviewed the document.

It may be determined whether the customer passed OFAC verification 1.5. If the customer did not pass, the personalized card order(s) may be rejected. If the customer did pass, then it may be verified whether the customer's CIP documents are valid. This may be valid on the back-end by comparing data from the CIP documents with information stored in one or more databases.

Since the customer has been verified by a documentary CIP method technically, it may be unnecessary to run a full Experian Level One check on these customers. However a full OFAC check can optionally be run. However, lack of SSN will not be a reason for rejection when another document is provided and the only thing needed from the Experian check is that the U.S. address given by the customer is a valid U.S. address. It is not necessary that the Experian check verify that the customer lives at that address. If the OFAC check is successful and the address given by the customer is a valid U.S. address, the replacement card order may be released for fulfillment. The customer may still have use of the Instant Issue card.

If the CIP document is found to be valid 1.6, then an instant issued card may be activated and a personalized card may be ordered 1.7. The instant issued card may be provided to the customer at the retailer site and may be immediately ready for use. The personalized card may be mailed to the customer.

To sell the Instant Issue card, the clerk may be required to enter the reference number on the card package into the system. The clerk may also enter the amount that is being loaded.

Orders for personalized replacement cards may be placed in a “pending” status if Experian Level 1 check for U.S. Citizens and OFAC for non-U.S. Citizens is unsuccessful. These orders will not be released until the cardholder and the Customer Service Rep. have successfully resolved the issue.

In some instances, an option to purchase family cards 1.8 may be provided. If no family cards are desired, only the personalized card may be mailed to the customer. If family cards are desired, then the system may fulfill personalized card orders for family cards 1.9.

In some instances, an OFAC verification may be performed in order to permit the family cards to be provided 1.10. The OFAC verification need not be performed on every member of the family. In some instances, the OFAC verification is only performed for the name that is provided on the family card. This may or may not be the same individual as the customer at the retailer site.

It may be determined whether the information provided for the family cards passes OFAC 1.11. If OFAC is not passed, then the family card order(s) may be rejected. In some instances, orders for family cards may be placed in a “pending” status if Experian Level 1 check for U.S. Citizens and/or OFAC for non-U.S. Citizens is unsuccessful. These orders will not be released until the cardholder and the Customer Service Rep. have successfully resolved the issue.

If the OFAC is passed, then personalized cards may be ordered 1.12. The personalized cards ordered may include family cards.

FIG. 4 shows additional steps that may be provided for a U.S. citizen for debit card issuance in accordance with an embodiment of the invention.

An enrollment process for a U.S. citizen 2.1 may occur. The enrollment process may include one or more steps described in the process above. For example, a U.S. citizen may desire to purchase a pre-paid debit card. The U.S. citizen may be at a retailer site and may purchase the card at the retailer site. The U.S. citizen may provide documentation relating to the U.S. citizen's identity. The documentation may be provided at the retailer site.

OFAC verification may occur 2.2. The OFAC may include comparing the documentation and/or information provided by the individual at the retailer with stored information. The stored information may or may not be provided remotely. The stored information may be accessed via a device at the retailer site, over a network.

It may be determined whether the individual passed OFAC 2.3. If OFAC was not passed, then the personalized card order(s) may be rejected. In some instances, orders for personalized cards may be placed in a “pending” status if Experian Level 1 check for U.S. Citizens and/or OFAC for non-U.S. Citizens is unsuccessful. These orders will not be released until the cardholder and the Customer Service Rep. have successfully resolved the issue.

If the individual did pass OFAC a call to customer service (CS) may be made to provide the SSN 2.4. For customers with a SSN, the store clerk may enter all of the data into the system with the exception of the Social Security Number. In some instances, the store clerks should not have access to SSN information. The customer may be instructed to call customer service to provide the SSN. The customer service may be hosted and/or operated by the card program manager, bank, or a third party entity. The customer may do so immediately or may wish to do so after leaving the store. In any case, the OFAC may be run and the Instant Issue card may still be sold and loaded, but the permanent card will not be shipped until enrollment has been completed. Cardholders may be able to complete the enrollment process by phone.

It may then be determined whether the SSN is valid 2.5. Such call and/or determination may be made at the retailer site, possibly in the presence of the customer. Alternatively, such call and/or determination may be made after departure of the customer with the instant access card. Such determination may be made at a location remote to the retailer site. In some instances, the retailer, program card manager, and/or bank may participate in making such a determination.

If the SSN is determined to be valid, an instant issued card may be activated and a personalized card may be ordered 2.6. The instant issued card may be activated while the customer is at the retailer. The customer may be able to use the card instantly.

Once the customer has provided a SSN to the program manager's customer service, the Experian Level 1 verification may be performed. If successful, the permanent replacement card may be fulfilled. If not, the customer may have to contact Customer Service to attempt to resolve the issue. The customer may still have use of the Instant Issue card and the customer will be refunded onto the instant-issue card if the permanent replacement card cannot be fulfilled. The customer may also be refunded onto the instant-issue card any monies paid for family cards if the permanent replacement card cannot be fulfilled.

In some instances, an option to purchase family cards 2.7 may be provided. If no family cards are desired, only the personalized card may be mailed to the customer. If family cards are desired, then the system may fulfill personalized card orders for family cards 2.8.

In some instances, an OFAC verification may be performed in order to permit the family cards to be provided 2.9. The OFAC verification need not be performed on every member of the family. In some instances, the OFAC verification is only performed for the name that is provided on the family card. This may or may not be the same individual as the customer at the retailer site.

It may be determined whether the information provided for the family cards passes OFAC 2.10. If OFAC is not passed, then the family card order(s) may be rejected. In some instances, orders for family cards may be placed in a “pending” status if Experian Level 1 check for U.S. Citizens and/or OFAC for non-U.S. Citizens is unsuccessful. These orders will not be released until the cardholder and the Customer Service Rep. have successfully resolved the issue.

If the OFAC is passed, then personalized cards may be ordered 2.11. The personalized cards ordered may include family cards.

Data handled herein may meet the payment card industry data security standard (PCI DSS).

It is to be understood that the present invention is not limited to the embodiments described above, but encompasses any and all embodiments within the scope of the following claims. It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method of card issuance comprising:
receiving information including information about identification documentation for a customer, wherein the information comprises at least one visual image of the identification documentation of the customer;
receiving a reference number associated with a given card package, wherein the card package contains a debit card, and wherein the given card package is associated with the customer;
receiving an image of the customer that is captured using an image capture device;
determining whether the customer is a U.S. citizen;
performing, with aid of a programmable processor, Office of Foreign Assets Control (OFAC) verification if the customer is not a U.S. citizen;
determining, with aid of a programmable processor and based on an assessment of the at least one visual image of the identification documentation and the image of the customer, whether the identification documentation for the customer is valid if the customer passes OFAC verification; and
activating the debit card of the given card package and ordering a personalized card if the identification documentation for the customer is determined to be valid.

2. The method of claim 1, wherein the image capture device comprises a camera.

3. The method of claim 1, wherein the image capture device comprises a scanner.

4. The method of claim 1, wherein the image capture device comprises a mobile device.

5. The method of claim 1, wherein the image capture device obtains the at least one visual image of the identification documentation at a retail location.

6. The method of claim 5, further comprising receiving, from the retailer, an indication that a clerk from the retailer has reviewed the identification information of the customer.

7. The method of claim 1, wherein the identification documentation comprises a driver's license.

8. The method of claim 1, wherein the identification documentation comprises a green card.

9. The method of claim 1, wherein the identification documentation comprises a passport.

10. The method of claim 1, wherein the personalized card comprises a family card.

11. A method of card issuance comprising:
receiving information including information about image-based identification documentation for a customer, wherein the image-based identification documentation is generated using an image capture device;
providing a reference number associated with a given card package, wherein the card package contains a debit card, and wherein the given card package is associated with the customer;
determining that the customer is not a U.S. citizen;
performing, with aid of a programmable processor, a verification that utilizes documents sufficient for an Office of Foreign Assets Control (OFAC) verification;
determining, based at least on an assessment of the image-based identification documentation, whether the identification documentation for the customer is valid; and
activating the debit card of the given card package and ordering a personalized card if the identification documentation for the customer is determined to be valid.

12. The method of claim 11, wherein the image-based identification documentation comprises an employment card.

13. The method of claim 11, wherein the image-based identification documentation comprises mail.

14. The method of claim 11, wherein the image capture device comprises a camera.

15. The method of claim 11, wherein the image capture device comprises a scanner.

16. The method of claim 11, wherein the image capture device comprises a mobile device.

17. A method of card issuance comprising:
generating visual images of identification documentation of a customer;
generating a reference number associated with a given card package, wherein the card package contains a debit card, and wherein the given card package is associated with the customer;
transmitting the visual images of the identification documentation and the reference number associated with the given card package to a program manager that:
a) determines whether the customer is a U.S. citizen;
b) performs, with aid of a programmable processor, a verification that utilizes documents sufficient for an Office of Foreign Assets Control (OFAC) verification;
c) determines, based on an assessment of the visual images of the identification documentation, whether the identification documentation for the customer is valid; and
d) transmits the results of the actions of b) and c) to the customer;
receiving the results of the actions of b) and c) from the program manager; and
activating the debit card of the given card package and ordering a personalized card if the identification documentation for the customer is determined to be valid.

18. The method of claim 17, wherein a retailer transmits the visual images of the identification documentation to the program manager and receives the results of the actions from the program manager to provide in-store registration of the card purchased by the customer.
